(19) United States
(12) Patent Application Publication
(10) Pub. No.: US 2010/0158681 A1
(43) Pub. Date: Jun. 24, 2010

(54) NI-BASED ALLOY FOR A FORGED PART OF A STEAM TURBINE WITH EXCELLENT HIGH TEMPERATURE STRENGTH, FORGEABILITY AND WELDABILITY, ROTOR BLADE OF A STEAM TURBINE, STATOR BLADE OF A STEAM TURBINE, SCREW MEMBER FOR A STEAM TURBINE, AND PIPE FOR A STEAM TURBINE

(75) Inventors: Kuniyoshi NEMOTO, Yokohama-shi (JP); Kiyoshi IMAI, Taito-ku (JP); Yomei YOSHIOKA, Yokohama-shi (JP); Masayuki YAMADA, Yokohama-shi (JP); Shigekazu MIYASHITA, Kawasaki-shi (JP); Takeo SUGA, Yokohama-shi (JP); Takeo TAKAHASHI, Yokohama-shi (JP); Kazutaka IKEDA, Mitaka-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/633,273

(22) Filed: Dec. 8, 2009

(30) Foreign Application Priority Data
Dec. 24, 2008 (JP) 2008-328460

(51) Int. Cl. F01D 9/02; F01D 5/28; F16L 9/02

(52) U.S. Cl. 415/200; 416/241 R; 138/177

(57) ABSTRACT

A Ni-based alloy for a forged part of a steam turbine having excellent high temperature strength, forgeability and weldability includes, in percentage by mass, 0.01 to 0.15 of C, 18 to 28 of Cr, 10 to 15 of Co, 8 to 12 of Mo, 1.5 to 2 of Al, 0.1 to 3 of Ti, 0.001 to 0.006 of B, 0.1 to 0.7 of Ta, and the balance of Ni plus unavoidable impurities.

### CROSS-REFERENCE TO RELATED APPLICATIONS

This application is based upon and claims the benefit of priority from the prior Japanese Patent Application No. 2008-328460 filed on Dec. 24, 2008; the entire contents which are incorporated herein by reference.

### BACKGROUND OF THE INVENTION

1. Field of the Invention

The present invention relates to a material making a forged part of a steam turbine in which a high temperature steam as a working fluid is flowed. Particularly, the present invention relates to a Ni-based alloy of a forged part of the steam turbine with excellent high temperature strength, forgeability and weldability, and a rotor blade of the steam turbine, a stator blade of the steam turbine, a screw member for the steam turbine and a pipe for the steam turbine which are made of the Ni-based alloy for the forged part of the steam turbine.

2. Description of the Related Art

In a thermal power plant including a steam turbine, an attention is paid to a CO₂ gas emission reduction technique in view of global environmental protection, and the high efficiency of generation of electricity is required.

In order to develop the efficiency of power generation of a steam turbine, it is effective that the temperature of the steam to be employed in the steam turbine is increased. In a recent thermal power plant with a steam turbine, the steam temperature is increased to 600° C. or more. In a future thermal power plant with a steam turbine, the steam temperature is likely to be increased up to 650° C. or 700° C.

The rotor blades, stator blades, screw members such as bolts, pipes and the like of the steam turbine, which are to be exposed to a high temperature steam, may cause large stresses therein as the temperature of the steam flowing around the rotor blades, stator blades, screw blades, pipes and the like of the steam turbine is increased. In this point of view, these parts of the steam turbine are required to resist against such a high temperature condition and such a high stress condition and thus, to be made of respective materials with excellent strength, ductility and toughness within a temperature range of room temperature through high temperature.

Particularly, when the steam temperature exceeds 700° C., a Ni-based alloy is considered to be used because a conventional Fe-based material cannot have enough high temperature strength (refer to Reference 1).

Since the Ni-based alloy has its excellent high temperature strength and high corrosion resistance, the Ni-based alloy would be employed mainly for jet engines and gas turbines. As the Ni-based alloy may be typically exemplified Inconel Alloy 617 (made by Special Metals Corporation and Inconel Alloy 706 (made by Special Metals Corporation).

The mechanism of enhancement in high temperature strength of the Ni-based alloy is originated from a precipitated phase such as a gamma prime phase (Ni₃(Al, Ti) and/or gamma double prime phase in the matrix phase of the Ni-based alloy by adding Al and Ti to the Ni-based alloy. In Inconel Alloy 706, both of the gamma prime phase and the gamma double prime phase are precipitated to develop the high temperature strength thereof.

In Inconel Alloy 617 or the like, on the other hand, Co and Mo are solid-solved (i.e., the use of solute strengthening) in the matrix phase of the Ni-based alloy so as to develop the high temperature strength thereof.

[Reference 1] JP-A 07-150277 (KOKAI)

As described above, although the Ni-based alloy is considered to be applied as a turbine rotor material of a steam turbine within a temperature range of more than 700° C., the high temperature strength is not enough for the Ni-based alloy to be employed under such a high temperature condition. Moreover, it is required that the high temperature strength of the Ni-based alloy is developed by the modification of the composition of the Ni-based alloy while the forgeability and weldability of the Ni-based alloy are maintained.

BRIEF SUMMARY OF THE INVENTION

It is an object of the present invention to provide a Ni-based alloy of a forged part of a steam turbine with excellent high temperature strength, forgeability and weldability, and a rotor blade of the steam turbine, a stator blade of the steam turbine, a screw member for the steam turbine and a pipe for the steam turbine which are made of the Ni-based alloy for the forged part of the steam turbine.

In order to achieve the object of the present invention, an aspect of the present invention relates to a Ni-based alloy for a forged part of a steam turbine having excellent high temperature strength, forgedability and weldability, including, in percentage by mass, 0.01 to 0.15 of C, 18 to 28 of Cr, 10 to 15 of Co, 8 to 12 of Mo, 1.5 to 2 of Al, 0.1 to 3 of Ti, 0.001 to 0.006 of B, 0.1 to 0.7 of Ta, and the balance of Ni plus unavoidable impurities.

Another aspect of the present invention relates to a

Ni-based alloy for a forged part of a steam turbine having excellent high temperature strength, forgedability and weldability, including, in percentage by mass, 0.01 to 0.15 of C, 18 to 28 of Cr, 10 to 15 of Co, 8 to 12 of Mo, 1.5 to 2 of Al, 0.1 to 3 of Ti, 0.001 to 0.006 of B, 0.1 to 0.4 of Nb, and the balance of Ni plus unavoidable impurities.

Still another aspect of the present invention relates to a Ni-based alloy for a forged part of a steam turbine having excellent high temperature strength, forgedability and weldability, including, in percentage by mass, 0.01 to 0.15 of C, 18 to 28 of Cr, 10 to 15 of Co, 8 to 12 of Mo, 1.5 to 2 of Al, 0.1 to 3 of Ti, 0.001 to 0.006 of B, 0.1 to 0.7 of Ta +2Nb (Ta:Nb in mole ratio is 1:2), and the balance of Ni plus unavoidable impurities.

A further aspect of the present invention relates to a rotor blade of a steam turbine, including at least a portion made of anyone of the Ni-based alloys as described above through forging.

A still further aspect of the present invention relates to a stator blade of a steam turbine, including at least a portion made of any one of the Ni-based alloys as described above through forging.

Another aspect of the present invention relates to a screw member for a steam turbine, including at least a portion made of any one of the Ni-based alloys as described above through forging.

Still another aspect of the present invention relates to a pipe for a steam turbine, including at least a portion made of any one of the Ni-based alloys as described above through forging.

According to the Ni-based alloy of a forged part of a steam turbine with excellent high temperature strength, forgeability and weldability, and the rotor blade of the steam turbine, the stator blade of the steam turbine, the screw member for the steam turbine and the pipe for the steam turbine which are made of the Ni-based alloy for the forged part of the steam turbine as set forth in the present invention, the high temperature strength, the forgeability and the weldability in the

Ni-based alloy and these parts of the present invention can be enhanced in comparison with the conventional ones.

### DETAILED DESCRIPTION OF THE INVENTION

Hereinafter, the present invention will be described in detail with reference to the drawings.

A Ni-based alloy of a forged part of a steam turbine with excellent high temperature strength, forgeability and weldability according to an embodiment of the present invention has a composition as described below. Here, the denomination “%” means “% by mass” unless otherwise specified.

(M1) C:0.01 to 0.15%, Cr: 18 to 28%, Co: 10 to 15%, Mo: 8 to 12%, Al: 1.5 to 2%, Ti: 0.1 to 3%, B: 0.001 to 0.006%, Ta:

0.1 to 0.7%, and the balance of Ni plus unavoidable impurities.

(M2) C:0.01 to 0.15%, Cr: 18 to 28%, Co: 10 to 15%, Mo: 8 to 12%, Al: 1.5 to2%, Ti: 0.1 to3%, B: 0.001 to 0.006%, Nb: 0.1 to 0.4%, and the balance of Ni plus unavoidable impurities.

(M3) C:0.01 to 0.15%, Cr: 18 to 28%, Co: 10 to 15%, Mo: 8 to 12%, Al: 1.5 to 2%, Ti: 0.1 to 3%, B: 0.001 to 0.006%, Ta+2Nb: 0.1 to 0.7%, and the balance of Ni plus unavoidable impurities. Here, the term “Ta+2Nb” means that Ta:Nb in mole ratio is 1:2.

With the unavoidable impurities of the Ni-based alloy numbered as (M1) to (M3), it is desired that the content of Si is set to 0.1% or less and the content of Mn is set to 0.1% or less. As the unavoidable impurities can be exemplified Cu, Fe and S in addition to Si and Mn.

The Ni-based alloy having such a composition as described above is preferable for a material making a forged part of a steam turbine which is operated within a temperature range of 680° C. to 750° C. As the forged part of the steam turbine may be exemplified a rotor blade of the steam turbine, a stator blade of the steam turbine, a screw member for the steam turbine and a pipe of the steam turbine.

As the screw member of the steam turbine may be exemplified a bolt and nut which are used for fixing a turbine casing and an interior component of the steam turbine. As the pipe for the steam turbine may be exemplified a pipe disposed at a steam turbine plant and used for the supply of a high-temperature and pressure steam, and an interior pipe of the steam turbine. Concretely, a main steam pipe for introducing the steam from a boiler into a high pressure turbine and a high temperature-reheat steam pipe for introducing the steam from a boiler reheater into a medium pressure turbine may be exemplified. Moreover, a main steam introduction pipe for introducing the high-temperature and pressure steam introduced into the steam turbine into a nozzle box may be exemplified. The steam turbine pipe is not limited to the above exemplified ones. For example, the steam turbine pipe encompasses another pipe in which a high temperature steam within a temperature range of 680° C. to 750° C. is flowed.

The rotor blade of the steam turbine, the stator blade of the steam turbine, the screw member for the steam turbine and the pipe for the steam turbine are disposed under a high-temperature and pressure atmosphere. Particularly, the rotor blade of the steam turbine, the stator blade of the steam turbine, and the pipe for the steam turbine are often disposed under the high-temperature and pressure atmosphere.

The Ni-based alloy may be applied for every portion of the forged part of the steam turbine or a portion of the forged part thereof. The forged parts of the steam turbine arranged over the high pressure steam turbine are likely to be disposed under the high-temperature and pressure atmosphere. Alternatively, the forged parts of the steam turbine arranged in the area from the high pressure steam turbine bridging to the a part of the medium pressure turbine are also likely to be disposed under the high-temperature and pressure atmosphere. Moreover, the main steam pipe for introducing the high-temperature and pressure steam into the corresponding steam turbine and the high temperature-reheater steam pipe are likely to be disposed under the high-temperature and pressure atmosphere. However, the pipe of the steam turbine to be disposed under the high-temperature and pressure atmosphere is not limited to the above-exemplified ones. In the present specification, the phrase of “the pipe of the steam turbine to be disposed under the high-temperature and pressure atmosphere” means a pipe of the steam turbine disposed and exposed to the temperature atmosphere within a temperature range of 680° C. to 750° C.

The Ni-based alloy as described above has a high temperature strength, forgedability and weldability superior than those of a conventional Ni-based alloy. Therefore, if the rotor blade of the steam turbine, the stator blade of the steam turbine, the screw member for the steam turbine and the pipe for the steam turbine are made of the Ni-based alloy of this embodiment according to the present invention, these can have the respective reliabilities under the high temperature atmosphere.

Then, the reason for defining the composition range of the Ni-based alloy according to the present invention will be described.

### (1) C (Carbon)

Carbon (C) is effective as a constituent element of M₂₃C₆ carbide functioning as reinforcing phase. Particularly, the precipitation of the M₂₃C₆ carbide during the operation of the steam turbine is one of main factors for maintaining the creep strength of an alloy (i.e., the Ni-based alloy) under a high temperature atmosphere of 650° C. or more. Alternatively, carbon has an effect of ensuring the fluidity of a hot melt during casting. When the carbon content is set less than 0.01%, the mechanical strength (hereinafter, often means a high temperature strength) of the Ni-based alloy may be reduced because the carbide cannot be sufficiently precipitated, and the fluidity of the hot melt of the Ni-based alloy during casting is reduced. In the production of the Ni-based alloy for a forged part according to the present invention, the Ni-based alloy with the composition defined in the present invention is melted and the thus obtained ingot is forged by means of rolling. In the production of the Ni-based alloy, in this point of view, the fluidity of the hot melt of the Ni-based alloy during casting is required. On the other hand, when the carbon content is set more than 0.15%, the composition segregation of the hot melt of the Ni-based alloy at the production of a large ingot of the Ni-based alloy is inclined to be increased and the creation of M₆C carbide as brittle phase is promoted. In this point of view, the carbon content is set within a range of 0.01 to 0.15%.

### (2) Cr (Chromium)

Chromium (Cr) is inevitable element for developing the oxidation resistance, the corrosion resistance and the mechanical strength of the Ni-based alloy, and inevitable as a constituent element of M₂₃C₆ carbide. Particularly, the precipitation of the M₂₃C₆ carbide during the operation of the steam turbine is one of main factors for maintaining the creep strength of an alloy (i.e., the Ni-based alloy) under a high temperature atmosphere of 650° C. or more. Alternatively, chromium has an effect of enhancing the oxidation resistance of the Ni-based alloy under a high temperature steam atmosphere. When the chromium content is set less than 18%, the oxidation resistance of the Ni-based alloy may be reduced. On the other hand, when the chromium content is set more than 28%, the precipitation of M₂₃C₆ carbide is remarkably promoted so as to increase the inclination of the coarsening of the precipitated M₂₃C₆ carbide. In this point of view, the chromium content is set within a range of 18 to 28%.

### (3) Co (Cobalt)

Cobalt (Co) is solid-solved into the matrix phase of the Ni-based alloy to enhance the mechanical strength of the matrix phase thereof. However, when the cobalt content is set more than 15%, such intermetallic compound phases as lowering the mechanical strength of the Ni-based alloy are generated so that the mechanical strength of the Ni-based alloy is reduced. On the other hand, when the cobalt content is set less than 10%, the processability (forgeability) of the Ni-based alloy is reduced and the mechanical strength of the Ni-based alloy is also reduced. In this point of view, the carbon content is set within a range of 10 to 15%.

### (4) Mo (Molybdenum)

Molybdenum (Mo) is solid-solved into the matrix phase of the Ni-based alloy to enhance the mechanical strength of the matrix phase thereof. Moreover, a part of the constituent elements of the M₂₃C₆ carbide is substituted with Mo elements to enhance the stability of the M₂₃C₆ carbide. When the Molybdenum content is set less than 8%, the above-described effect/function cannot be exhibited. When the Molybdenum content is set more than 12%, the composition segregation of the hot melt of the Ni-based alloy at the production of a large ingot of the Ni-based alloy is inclined to be increased and the creation of M₆C carbide as brittle phase is promoted. In this point of view, the molybdenum content is set within a range of 8 to 12%.

### (5) Al (Aluminum)

Aluminum (Al) generates a γ′ phase (gamma prime phase: Ni₃A1) with nickel so as to develop the mechanical strength of the Ni-based alloy through the precipitation of the γ′ phase. When the aluminum content is set less than 1.5%, the mechanical strength and the processability (forgedability) of the Ni-based alloy are not developed in comparison with a conventional steel. When the aluminum content is set more than 2%, the mechanical strength of the Ni-based alloy is developed, but the forgedability (processability) of the Ni-based alloy is not developed. In this point of view, the aluminum content is set within a range of 1.5 to 2%.

### (6) Ti (Titanium)

Titanium (Ti) generates a γ′ phase (gamma prime phase: Ni₃A1) with nickel in the same manner as aluminum so as to develop the mechanical strength of the Ni-based alloy. When the titanium content is set less than 0.1%, the mechanical strength and the processability (forgedability) of the Ni-based alloy are not developed. When the titanium content is set more than 3%, the mechanical strength of the Ni-based alloy is developed, but the forgedability (processability) of the Ni-based alloy is not developed. In this point of view, the titanium content is set within a range of 0.1 to 3%.

### (7) B (Boron)

Boron (B) is solid-solved into the matrix phase of the Ni-based alloy to enhance the mechanical strength of the matrix phase thereof. When the boron content is set less than 0.001%, the mechanical strength of the matrix phase thereof cannot be developed. When the boron content is set more than 0.006%, grain boundary embrittlement may be caused in the Ni-based alloy. In this point of view, the boron content is set within a range of 0.001 to 0.006%.

### (8) Ta (Tantalum)

Tantalum (Ta) stabilizes the precipitation strengthening of the γ′ phase (gamma prime phase (Ni₃(Al, Ti)). When the tantalum content is set less than 0.1%, the stability of the precipitation strengthening cannot be enhanced in comparison with a conventional steel. When the tantalum content is set more than 0.7%, the production cost of the Ni-based alloy is increased so that the economic efficiency is deteriorated. In this point of view, the tantalum content is set within a range of 0.1 to 0.7%.

### (9) Nb (Niobium)

Niobium (Nb) is solid-solved into the γ′ phase (gamma prime phase (Ni₃(Al, Ti)) so as to stabilize the precipitation strengthening thereof in the same manner as Tantalum (Ta). When the niobium content is set less than 0.1%, the stability of the precipitation strengthening cannot be enhanced in comparison with a conventional steel. When the niobium content is set more than 0.4%, the mechanical strength of the Ni-based alloy is developed, but the processability (forgedability) is reduced. In this point of view, the niobium content is set within a range of 0.1 to 0.4%.

With Ta and Nb, the precipitation strengthening of the γ′ phase (gamma prime phase (Ni₃(Al, Ti) can be developed by setting the total content represented by the expression (Ta+2Nb) within a range of 0.1 to 0.7%. When the total content of (Ta+2Nb) is set less than 0.1%, the precipitation strengthening may not be developed sufficiently in comparison with a conventional steel. When the total content of (Ta+2Nb) is set more than 0.7%, the mechanical strength of the Ni-based alloy is developed, but the processability (forgedability) of the Ni-based alloy may be reduced. The tantalum content and the niobium content are set at least to 0.01% or more, respectively.

Since the specific gravity of niobium is about half as large as the specific gravity of tantalum (specific gravity of tantalum: 16.6, specific gravity of niobium: 8.57), the total solid solubility into the matrix phase of the Ni-based alloy can be increased by adding tantalum and niobium in combination into the matrix phase thereof in comparison with the addition of tantalum. Moreover, since tantalum is a strategic substance, it is difficult to obtain it stably. On the other hand, since the reserve of niobium is about one hundred times as much as the reserve of tantalum, niobium can be stably supplied. Since the melting point of tantalum is higher than the melting point of niobium (melting point of tantalum: about 3000° C., melting point of niobium: about 2470° C.), the γ′ phase is strengthened under a higher temperature condition. In addition, the oxidation resistance of tantalum is superior than the oxidation resistance of niobium. (10) Si (Silicon), Mn (Manganese), Cu (Copper), Fe (iron) and S (Sulfur)

With the Ni-based alloy according to the present invention, silicon (Si), manganese (Mn), copper (Cu), iron (Fe) and sulfur (S) are classified as unavoidable impurities. It is desired that the remaining contents of these impurities are reduced to zero % as possible. It is desired that the remaining contents of at least silicon (Si) and manganese (Mn) among these impurities are set to 0.1% or less, respectively.

In a plain carbon steel, silicon (Si) is added thereto for compensating the poor corrosion resistance thereof. However, since the Ni-based alloy contains a relatively large amount of chromium (Cr) to ensure the corrosion resistance of the Ni-based alloy, the remaining content of silicon (Si) in the Ni-based alloy is set to 0.1% or less and then, desirably reduced to zero % as possible.

In a plain carbon steel, manganese (Mn) constitutes manganese sulfide (MnS) with sulfur (S) so as to suppress the brittleness of the Ni-based alloy because sulfur (S) may cause the brittleness for the plain carbon steel. However, since the remaining content of sulfur (S) in the Ni-based alloy is extremely low, it is not required to add manganese (Mn) into the Ni-based alloy. In this point of view, the remaining content of manganese (Mn) is set to 0.1% or less and then, desirably reduced to zero % as possible.

The Ni-based alloy for a forged part of a steam turbine according to the present invention, which is described above, can be produced as follows: First of all, the composition of the Ni-based alloy is melted by means of vacuum induction melting (VIM) and the thus obtained hot melt is injected into a molding box to form an ingot. Then, the ingot is treated by means of soaking treatment, forged by means of rolling or the like and also treated by means of solution treatment.

The soaking treatment is preferably conducted for 5 to 72 hours within a temperature range of 1050 to 1250° C. The solution treatment is preferably conducted for 4 to 15 hours within a temperature range of 1100 to 1200° C. The solution treatment is conducted in order to solid-solve the γ′ precipitated phase uniformly. When the temperature in the solution treatment is set less than 1100° C., the solid-solution cannot be conducted sufficiently. When the temperature in the solution treatment is set more than 1200° C., the strength of the Ni-based alloy is reduced due to the coarsening of crystal grains thereof. The forging is conducted within a temperature range of 950 to 1150° C.

The rotor blade of the steam turbine, the stator blade of the steam turbine and the screw member for the steam turbine according to the present invention may be manufactured as follows. These parts are respective forged parts as described above. First of all, the composition of the Ni-based alloy for the forged part of the steam turbine according to the present invention is melted by means of vacuum induction melting (VIM) and remelted by means of electroslag remelting (ESR). The thus obtained hot melt is injected into a molding box under a depressurized atmosphere, and treated by means of soaking treatment. Then, the thus obtained ingot is disposed into a predetermined molding commensurate with the shape of the forged part such as the rotor blade of the steam turbine or the like, forged by means of rolling or the like and also treated by means of solution treatment. In this way, the rotor blade of the steam turbine, the stator blade of the steam turbine and the screw member for the steam turbine are manufactured. Namely, the rotor blade of the steam turbine, the stator blade of the steam turbine and the screw member for the steam turbine are manufactured by means of die forging.

The rotor blade of the steam turbine, the stator blade of the steam turbine and the screw member for the steam turbine may be also manufactured as follows: First of all, the composition of the Ni-based alloy for the forged part of the steam turbine according to the present invention is melted by means of vacuum induction melting (VIM) and remelted by means of vacuum arc remelting (VAR). The thus obtained hot melt is injected into a molding box under a depressurized atmosphere, and treated by means of soaking treatment. Then, the thus obtained ingot is disposed into a predetermined molding commensurate with the shape of the forged part such as the rotor blade of the steam turbine or the like, forged by means of rolling or the like and also treated by means of solution treatment.

Alternatively, the rotor blade of the steam turbine, the stator blade of the steam turbine and the screw member for the steam turbine may be also manufactured as follows: First of all, the composition of the Ni-based alloy for the forged part of the steam turbine according to the present invention is melted by means of vacuum induction melting (VIM) and remelted by means of electroslag remelting (ESR) and vacuum arc remelting (VAR).

The thus obtained hot melt is injected into a molding box under a depressurized atmosphere, and treated by means of soaking treatment. Then, the thus obtained ingot is disposed into a predetermined molding commensurate with the shape of the forged part such as the rotor blade of the steam turbine or the like, forged by means of rolling or the like and also treated by means of solution treatment.

On the other hand, the pipe for the steam turbine as a forged part may be manufactured as follows: First of all, the composition of the Ni-based alloy for the forged part of the steam turbine according to the present invention is melted by means of electric furnace (EF) and decarburized by means of argon-oxygen decarburization (AOD). The thus obtained ingot is treated by means of soaking treatment, and bored by means of vertical press to form a cup-shaped elementary pipe. Then, the processing using a lateral press and reheating are conducted repeatedly for the elementary pipe to form the intended pipe for the steam turbine. In the processing using the lateral press, a mandrel and a dice are employed. Such a processing method is called as Erhardt Push Bench Pipe Manufacturing.

The manufacturing methods for the rotor blade of the steam turbine, the stator blade of the steam turbine, the screw member for the steam turbine and the pipe for the steam turbine are not limited to the above-described ones.

The excellent high temperature strength, forgedability and weldability of the Ni-based alloy for the forged part of the steam turbine will be described hereinafter.

### (Evaluation of High Temperature Strength, Forgedability and Weldability)

Here, the excellent high temperature strength, forgedability and weldability of the Ni-based alloy for the forged part of the steam turbine, which has a composition within the composition range defined according to the present invention as described above, will be described. Table 1 shows the chemical compositions of Sample 1 to Sample 28 which are supplied for the evaluation of high temperature strength, the forgedability and the weldability. The chemical compositions of Sample 1 to Sample 6 are belonging to the chemical composition range defined in the present invention. The chemical compositions of Sample 7 to Sample 28 are not belonging to the chemical composition range defined in the present invention. Therefore, Sample 7 to Sample 28 correspond to Comparative Examples, respectively. Sample 7 has a chemical composition equal to the chemical composition of a conventional Inconel Alloy 617. In this case, the Ni-based alloy of each of Samples contains iron (Fe), copper (Cu) and sulfur (S) in addition to silicon (Si) and manganese (Mn) as unavoidable impurities.

TABLE 1
(% by mass)

| | | Ni | C | Si | Mn | Cr | Fe | Al |
|---|---|---|---|---|---|---|---|---|
| Example | Sample 1 | Balance | 0.051 | less than 0.01 | less than 0.01 | 23.2 | 1.55 | 1.72 |
| | Sample 2 | Balance | 0.049 | less than 0.01 | less than 0.01 | 23.38 | 1.58 | 1.77 |
| | Sample 3 | Balance | 0.052 | less than 0.01 | less than 0.01 | 22.58 | 1.48 | 1.75 |
| | Sample 4 | Balance | 0.051 | less than 0.01 | less than 0.01 | 23.27 | 1.57 | 1.77 |
| | Sample 5 | Balance | 0.050 | less than 0.01 | less than 0.01 | 23.40 | 1.59 | 1.78 |
| | Sample 6 | Balance | 0.050 | less than 0.01 | less than 0.01 | 23.50 | 1.58 | 1.78 |
| Compar- | Sample 7 | Balance | 0.098 | 0.51 | 0.55 | 23.14 | 1.51 | 1.27 |
| ative | Sample 8 | Balance | 0.095 | less than 0.01 | less than 0.01 | 22.43 | 1.46 | 1.28 |
| Example | Sample 9 | Balance | 0.010 | less than 0.01 | less than 0.01 | 22.44 | 1.53 | 1.24 |
| | Sample 10 | Balance | 0.172 | less than 0.01 | less than 0.01 | 22.80 | 1.53 | 1.32 |
| | Sample 11 | Balance | 0.096 | less than 0.01 | less than 0.01 | 17.85 | 1.44 | 1.24 |
| | Sample 12 | Balance | 0.097 | less than 0.01 | less than 0.01 | 28.32 | 1.55 | 1.23 |
| | Sample 13 | Balance | 0.095 | less than 0.01 | less than 0.01 | 22.90 | 1.48 | 1.20 |
| | Sample 14 | Balance | 0.099 | less than 0.01 | less than 0.01 | 23.11 | 1.55 | 1.22 |
| | Sample 15 | Balance | 0.094 | less than 0.01 | less than 0.01 | 22.67 | 1.47 | 1.25 |
| | Sample 16 | Balance | 0.096 | less than 0.01 | less than 0.01 | 22.29 | 1.44 | 1.24 |
| | Sample 17 | Balance | 0.097 | less than 0.01 | less than 0.01 | 22.78 | 1.55 | 1.41 |
| | Sample 18 | Balance | 0.099 | less than 0.01 | less than 0.01 | 23.11 | 1.48 | 2.24 |
| | Sample 19 | Balance | 0.096 | less than 0.01 | less than 0.01 | 23.20 | 1.42 | 1.25 |
| | Sample 20 | Balance | 0.095 | less than 0.01 | less than 0.01 | 22.42 | 1.49 | 1.27 |
| | Sample 21 | Balance | 0.097 | less than 0.01 | less than 0.01 | 22.85 | 1.51 | 1.33 |
| | Sample 22 | Balance | 0.095 | less than 0.01 | less than 0.01 | 22.68 | 1.55 | 1.28 |
| | Sample 23 | Balance | 0.099 | less than 0.01 | less than 0.01 | 23.20 | 1.55 | 1.31 |
| | Sample 24 | Balance | 0.087 | less than 0.01 | less than 0.01 | 22.65 | 1.61 | 1.33 |
| | Sample 25 | Balance | 0.091 | less than 0.01 | less than 0.01 | 22.58 | 1.46 | 1.26 |
| | Sample 26 | Balance | 0.088 | less than 0.01 | less than 0.01 | 22.69 | 1.53 | 1.21 |
| | Sample 27 | Balance | 0.090 | less than 0.01 | less than 0.01 | 22.75 | 1.44 | 1.29 |
| | Sample 28 | Balance | 0.092 | less than 0.01 | less than 0.01 | 23.10 | 1.47 | 1.33 |

| | | Mo | Co | Cu | Ti | B | S | Ta | Nb |
|---|---|---|---|---|---|---|---|---|---|
| Example | Sample 1 | 9.05 | 12.49 | 0.25 | 0.35 | 0.0038 | 0.0012 | 0.11 | 0 |
| | Sample 2 | 9.19 | 12.73 | 0.24 | 0.33 | 0.0031 | 0.0006 | 0.69 | 0 |
| | Sample 3 | 9.20 | 12.28 | 0.24 | 0.32 | 0.0019 | 0.0010 | 0 | 0.10 |
| | Sample 4 | 9.21 | 12.73 | 0.24 | 0.34 | 0.0032 | 0.0008 | 0 | 0.37 |
| | Sample 5 | 9.23 | 12.72 | 0.24 | 0.33 | 0.0032 | 0.0005 | Ta + 2Nb = 0.15 | |
| | | | | | | | | (Ta: 0.05, 2Nb: 0.1) | |
| | Sample 6 | 9.22 | 12.50 | 0.24 | 0.35 | 0.0030 | 0.0010 | Ta + 2Nb = 0.6 | |
| | | | | | | | | (Ta: 0.2, 2Nb: 0.4) | |
| Compar- | Sample 7 | 9.12 | 12.32 | 0.25 | 0.35 | 0.0040 | 0.0009 | 0 | 0 |
| ative | Sample 8 | 9.09 | 12.29 | 0.23 | 0.30 | 0.0030 | 0.0008 | 0 | 0 |
| Example | Sample 9 | 9.15 | 12.23 | 0.23 | 0.33 | 0.0020 | 0.0011 | 0 | 0 |
| | Sample 10 | 9.11 | 12.52 | 0.25 | 0.28 | 0.0032 | 0.0008 | 0 | 0 |
| | Sample 11 | 9.20 | 12.17 | 0.23 | 0.30 | 0.0020 | 0.0013 | 0 | 0 |
| | Sample 12 | 9.15 | 12.33 | 0.24 | 0.35 | 0.0038 | 0.0010 | 0 | 0 |
| | Sample 13 | 7.86 | 12.30 | 0.25 | 0.35 | 0.0035 | 0.0010 | 0 | 0 |
| | Sample 14 | 13.05 | 12.22 | 0.25 | 0.33 | 0.0038 | 0.0012 | 0 | 0 |
| | Sample 15 | 9.19 | 8.90 | 0.24 | 0.30 | 0.0024 | 0.0005 | 0 | 0 |
| | Sample 16 | 8.88 | 16.82 | 0.23 | 0.31 | 0.0031 | 0.0013 | 0 | 0 |
| | Sample 17 | 9.12 | 12.45 | 0.25 | 0.35 | 0.0040 | 0.0010 | 0 | 0 |
| | Sample 18 | 9.18 | 12.38 | 0.25 | 0.33 | 0.0036 | 0.0010 | 0 | 0 |
| | Sample 19 | 9.11 | 12.33 | 0.25 | 0.08 | 0.0038 | 0.0010 | 0 | 0 |
| | Sample 20 | 9.08 | 12.39 | 0.23 | 3.25 | 0.0033 | 0.0009 | 0 | 0 |
| | Sample 21 | 9.00 | 12.35 | 0.25 | 0.31 | 0.0006 | 0.0011 | 0 | 0 |
| | Sample 22 | 9.13 | 12.28 | 0.25 | 0.35 | 0.0072 | 0.0010 | 0 | 0 |
| | Sample 23 | 9.05 | 12.49 | 0.25 | 0.35 | 0.0038 | 0.0012 | 0.08 | 0 |
| | Sample 24 | 9.14 | 12.39 | 0.24 | 0.30 | 0.0041 | 0.0010 | 1.20 | 0 |
| | Sample 25 | 9.20 | 12.28 | 0.24 | 0.32 | 0.0019 | 0.0010 | 0 | 0.06 |
| | Sample 26 | 9.15 | 12.30 | 0.24 | 0.35 | 0.0032 | 0.0010 | 0 | 0.64 |

| | | | | | | | |
|---|---|---|---|---|---|---|---|
| Sample 27 | 9.01 | 12.40 | 0.25 | 0.32 | 0.0031 | 0.0008 | Ta + 2Nb = 0.08 |
| | | | | | | | (Ta: 0.02, 2Nb: 0.06) |
| Sample 28 | 9.00 | 12.39 | 0.25 | 0.32 | 0.0029 | 0.0008 | Ta + 2Nb = 1.0 |
| | | | | | | | (Ta: 0.3, 2Nb: 0.7) |

The high temperature strength was evaluated by tensile strength test. In the tensile strength test, 20 kg of the Ni-based alloy was melted in vacuum induction melting furnace to form an ingot per Sample (i.e., Sample 1 to Sample 28). As described above, Sample 1 to Sample 28 have the corresponding chemical composition listed in Table 1. Subsequently, soaking treatment was conducted for the ingot for five hours at 1050° C., forged by a hammer forging machine of 500 kgf within a temperature range of 950 to 1100° C. (reheating temperature: 1100° C.), and treated by means of solution treatment for four hours and at 1180° C., thereby forming a forging steel. Sample was made of the forging steel and shaped in a predetermined size.

Then, the tensile strength test was conducted per Sample on JIS G 0567 (Method of elevated temperature tensile test for steels and heat-resisting alloys) at temperatures of 23° C., 700° C. and 800° C. In this case, 0.2% proof stress was measured. The testing temperatures of 700° C. and 800° C. were set in view of the temperature condition and the safety factor thereof at a normal operation of a steam turbine. The measurement result of the 0.2% proof stress is listed per Sample in Table 2.

Moreover, forgedability was evaluated per Sample by forging each of Samples until the forging ratio becomes nine on JIS G 0701 (Symbols of forming ratio for steel forging) and visually evaluating the occurrence of forging crack. The forging was conducted within a temperature range of 950 to 1100° C. When the temperature of Sample was decreased during the forging, that is, Sample was hardened during the forging, Sample was reheated up to 1100° C. so as to repeat the forging. The forging evaluation result is listed per Sample in Table 2. Here, the case of no forging crack is indicated by the term “not occurrence”. In this case, since the forgedability is excellent, the forging evaluation is indicated by the symbol “ο”. The case of forging crack is indicated by the term “occurrence”. In this case, since the forgedability is poor, the forging evaluation is indicated by the symbol “×”.

Moreover, weldability was evaluated per Sample. In this case, the sample size was set to 60 mm in width, 150 mm in length and 40 mm in thickness when each of Samples was formed from the forging steel. A trench with a width of 10 mm and a depth of 5 mm was formed at each of Samples so as to be elongated along the long direction thereof at almost the center in the width direction thereof. Then, arc heating to be employed in TIG welding was conducted for the trench so that each of Samples was cut off in the thickness direction at the trench so as to be parallel to the width direction. Then, liquid penetrant test (PT) of welded heat affected zone was conducted for the cutting surface of each of Samples on JIS Z 2343-1 (Non-destructive testing—Penetrant testing—Part 1: General principles—Method for liquid penetrant testing and classification of the penetrant indication). Then, the occurrence of weld crack was visually evaluated for each of Samples. The welding evaluation result is listed per Sample in Table 2. Here, the case of no weld crack is indicated by the term “not occurrence”. In this case, since the weldability is excellent, the welding evaluation is indicated by the symbol “ο”. The case of weld crack is indicated by the term “occurrence”. In this case, since the weldability is poor, the welding evaluation is indicated by the symbol “×”.

| | | 0.2% proof stress, Mpa | | | Forgedability | | Weldability | |
|---|---|---|---|---|---|---|---|---|
| | | 23° C. | 700° C. | 800° C. | Forging crack | Evaluation | Welding crack | Evaluation |
| Example | Sample 1 | 441 | 371 | 361 | Not occurrence | ◯ | Not occurrence | ◯ |
| | Sample 2 | 444 | 392 | 377 | Not occurrence | ◯ | Not occurrence | ◯ |
| | Sample 3 | 436 | 369 | 340 | Not occurrence | ◯ | Not occurrence | ◯ |
| | Sample 4 | 438 | 374 | 359 | Not occurrence | ◯ | Not occurrence | ◯ |
| | Sample 5 | 442 | 385 | 365 | Not occurrence | ◯ | Not occurrence | ◯ |
| | Sample 6 | 448 | 402 | 379 | Not occurrence | ◯ | Not occurrence | ◯ |
| Compar- | Sample 7 | 338 | 262 | 247 | Not occurrence | ◯ | Not occurrence | ◯ |
| ative | Sample 8 | 340 | 273 | 260 | Not occurrence | ◯ | Not occurrence | ◯ |
| Example | Sample 9 | 282 | 146 | 134 | Not occurrence | ◯ | Not occurrence | ◯ |
| | Sample 10 | 364 | 329 | 305 | Occurrence | X | Occurrence | X |
| | Sample 11 | 344 | 263 | 246 | Not occurrence | ◯ | Not occurrence | ◯ |
| | Sample 12 | 348 | 269 | 250 | Not occurrence | ◯ | Not occurrence | ◯ |
| | Sample 13 | 340 | 267 | 255 | Not occurrence | ◯ | Not occurrence | ◯ |
| | Sample 14 | 350 | 289 | 269 | Occurrence | X | Not occurrence | ◯ |
| | Sample 15 | 345 | 259 | 239 | Not occurrence | ◯ | Not occurrence | ◯ |
| | Sample 16 | 367 | 288 | 272 | Occurrence | X | Occurrence | X |
| | Sample 17 | 392 | 297 | 270 | Not occurrence | ◯ | Not occurrence | ◯ |
| | Sample 18 | 575 | 495 | 366 | Occurrence | X | Occurrence | X |
| | Sample 19 | 324 | 246 | 235 | Not occurrence | ◯ | Not occurrence | ◯ |
| | Sample 20 | 479 | 345 | 307 | Occurrence | X | Occurrence | X |
| | Sample 21 | 341 | 258 | 244 | Not occurrence | ◯ | Not occurrence | ◯ |
| | Sample 22 | 353 | 264 | 251 | Not occurrence | ◯ | Not occurrence | ◯ |
| | Sample 23 | 347 | 267 | 255 | Not occurrence | ◯ | Not occurrence | ◯ |
| | Sample 24 | 359 | 298 | 279 | Occurrence | X | Not occurrence | ◯ |
| | Sample 25 | 343 | 276 | 255 | Not occurrence | ◯ | Not occurrence | ◯ |
| | Sample 26 | 354 | 285 | 274 | Not occurrence | ◯ | Not occurrence | ◯ |
| | Sample 27 | 343 | 270 | 254 | Not occurrence | ◯ | Not occurrence | ◯ |
| | Sample 28 | 355 | 288 | 277 | Not occurrence | ◯ | Not occurrence | ◯ |

It was turned out that Sample 1 to Sample 6 have respective higher 0.2% proof stresses, and excellent forgedability and weldability. The reason why Sample 1 to Sample 6 have the respective higher 0.2% proof stresses is considered due to precipitation strengthening and solute strengthening.

For example, in contrast, Sample 18 and Sample 20 have the respective higher 0.2% proof stresses, but poor forgedability and weldability. All of the conventional steels relating to Comparative Examples cannot exhibit excellent high temperature strength, forgedability and weldability.

Although the present invention was described in detail with reference to the above examples, this invention is not limited to the above disclosure and every kind of variation and modification may be made without departing from the scope of the present invention.

What is claimed is:

1. A Ni-based alloy for a forged part of a steam turbine having excellent high temperature strength, forgedability and weldability, comprising,
in percentage by mass, 0.01 to 0.15 of C, 18 to 28 of Cr, 10 to 15 of Co, 8 to 12 of Mo, 1.5 to 2 of Al, 0.1 to 3 of Ti, 0.001 to 0.006 of B, 0.1 to 0.7 of Ta, and the balance of Ni plus unavoidable impurities.

2. The Ni-based alloy as set forth in claim 1,
wherein contents of at least Si and Mn selected from among the unavoidable impurities are set to 0.1 or less, respectively.

3. A Ni-based alloy for a forged part of a steam turbine having excellent high temperature strength, forgedability and weldability, comprising,
in percentage by mass, 0.01 to 0.15 of C, 18 to 28 of Cr, 10 to 15 of Co, 8 to 12 of Mo, 1.5 to 2 of Al, 0.1 to 3 of Ti, 0.001 to 0.006 of B, 0.1 to 0.4 of Nb, and the balance of Ni plus unavoidable impurities.

4. The Ni-based alloy as set forth in claim 3,
wherein contents of at least Si and Mn selected from among the unavoidable impurities are set to 0.1 or less, respectively.

5. A Ni-based alloy for a forged part of a steam turbine having excellent high temperature strength, forgedability and weldability, comprising,
in percentage by mass, 0.01 to 0.15 of C, 18 to 28 of Cr, 10 to 15 of Co, 8 to 12 of Mo, 1.5 to 2 of Al, 0.1 to 3 of Ti, 0.001 to 0.006 of B, 0.1 to 0.7 of Ta +2Nb (Ta:Nb in mole ratio is 1:2), and the balance of Ni plus unavoidable impurities.

6. The Ni-based alloy as set forth in claim 5,
wherein contents of at least Si and Mn selected from among the unavoidable impurities are set to 0.1 or less, respectively.

7. A rotor blade of a steam turbine, comprising,
at least a portion made of a Ni-based alloy as set forth in claim 1 through forging.

8. A rotor blade of a steam turbine, comprising
at least a portion made of a Ni-based alloy as set forth in claim 3 through forging.

9. A rotor blade of a steam turbine, comprising
at least a portion made of a Ni-based alloy as set forth in claim 5 through forging.

10. A stator blade of a steam turbine, comprising,
at least a portion made of a Ni-based alloy as set forth in claim 1 through forging.

11. A stator blade of a steam turbine, comprising,
at least a portion made of a Ni-based alloy as set forth in claim 3 through forging.

12. A stator blade of a steam turbine, comprising,
at least a portion made of a Ni-based alloy as set forth in claim 5 through forging.

13. A screw member for a steam turbine, comprising,
at least a portion made of a Ni-based alloy as set forth in claim 1 through forging.

14. A screw member for a steam turbine, comprising,
at least a portion made of a Ni-based alloy as set forth in claim 3 through forging.

15. A screw member for a steam turbine, comprising,
at least a portion made of a Ni-based alloy as set forth in claim 5 through forging.

16. A pipe for a steam turbine, comprising,
at least a portion made of a Ni-based alloy as set forth in claim 1 through forging.

17. A pipe for a steam turbine, comprising,
at least a portion made of a Ni-based alloy as set forth in claim 3 through forging.

18. A pipe for a steam turbine, comprising,
at least a portion made of a Ni-based alloy as set forth in claim 5 through forging.
